(19) United States
(12) Patent Application Publication
(10) Pub. No.: US 2023/0167278 A1
(43) Pub. Date: Jun. 1, 2023

(54) TIRE RUBBER COMPOSITION AND TIRE

(71) Applicant: TOYO TIRE CORPORATION, Itami-shi (JP)

(72) Inventor: Asuka Noda, Itami-shi (JP)

(73) Assignee: TOYO TIRE CORPORATION, Itami-shi (JP)

(21) Appl. No.: 17/985,357

(22) Filed: Nov. 11, 2022

(30) Foreign Application Priority Data
Nov. 29, 2021 (JP) 2021-192955

(51) Int. Cl. C08L 7/00; B60C 1/00

(52) U.S. Cl. CPC C08L 7/00; B60C 1/0016; B60C 2200/06

(57) ABSTRACT

A tire rubber composition according to an embodiment contains: 20 parts by mass to 45 parts by mass of carbon black and 5 parts by mass to 30 parts by mass of silica with respect to 100 parts by mass of a diene rubber containing a tin-modified polybutadiene rubber; a compound represented by a General Formula (1) and/or a compound represented by a General Formula (2); and a silane coupling agent. In the Formula (1), R¹ and R² represent a hydrogen atom, an alkyl group, an alkenyl group, or an alkynyl group, and M⁺ represents Na⁺, K⁺, or Li⁺. In the Formula (2), A represents an aromatic ring group, a hydantoin ring group, or a linear hydrocarbon group.

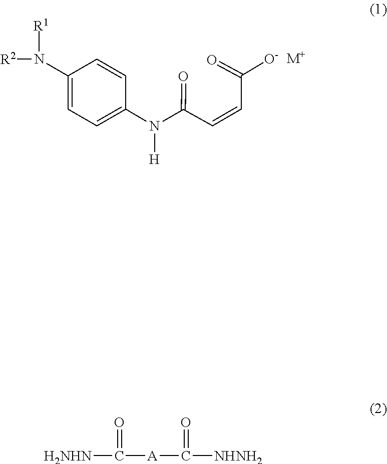

### CROSS-REFERENCE TO RELATED APPLICATION

This application is based upon and claims the benefit of priority from the prior Japanese Patent Application No. 2021-192955, filed on Nov. 29, 2021; the entire contents of which are incorporated herein by reference.

### BACKGROUND OF THE INVENTION

### 1. Field of the Invention

The present invention relates to a tire rubber composition and a tire using the tire rubber composition.

### 2. Description of the Related Art

It is known that a modified polybutadiene rubber is compounded in a tire rubber composition. For example, JP-A-2019-123760 discloses a rubber composition in which silica and a rosin resin are compounded in a rubber component containing a styrene-butadiene rubber and a butadiene rubber, and discloses that a modified low-cis butadiene rubber is used as the butadiene rubber.

JP-A-2015-120783 discloses that a tin-modified polybutadiene rubber polymerized by using a lithium initiator is compounded together with carbon black and a sulfide compound containing a nitrogen functional group, as a rubber composition having excellent fuel economy while maintaining excellent rubber processability by compounding carbon black.

JP-A-2012-158679 discloses a rubber composition in which silica and a silane coupling agent are compounded in a rubber component containing a natural rubber in order to improve fuel economy, abrasion resistance, and the like in a balanced manner, and further discloses that a tin-modified butadiene rubber polymerized by using a lithium initiator is compounded.

### SUMMARY OF THE INVENTION

In a rubber composition used for a tire, in particular, a tread of a heavy duty tire, low heat generation is required in order to reduce environmental loads and improve fuel economy. In addition, in order to improve rigidity of the tire and steering stability, an improvement in modulus (elastic modulus) is required. The rubber composition in the related art is not necessarily sufficient in terms of a low heat generation property and a high modulus, and a further improvement is required.

An object of the invention is to provide a tire rubber composition capable of improving low heat generation property and improving a modulus, and a tire using the tire rubber composition.

A tire rubber composition according to an embodiment of the invention contains: a diene rubber containing a tin-modified polybutadiene rubber; and 20 parts by mass to 45 parts by mass of carbon black and 5 parts by mass to 30 parts by mass of silica with respect to 100 parts by mass of the diene rubber. The tire rubber composition further contains: at least one selected from the group consisting of a compound represented by the following General Formula (1) and a compound represented by the following General Formula (2); and a silane coupling agent.

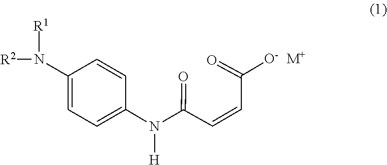

In the Formula (1), R¹ and R² each independently represent a hydrogen atom, an alkyl group having 1 to 20 carbon atoms, an alkenyl group having 2 to 20 carbon atoms, or an alkynyl group having 2 to 20 carbon atoms. M⁺ represents a sodium ion, a potassium ion, or a lithium ion.

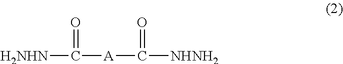

In the Formula (2), A represents a divalent aromatic ring group, a substituted or unsubstituted divalent hydantoin ring group, or a saturated or unsaturated divalent linear hydrocarbon group having 1 to 18 carbon atoms.

A tire according to an embodiment of the invention is produced using the above tire rubber composition.

According to the embodiment of the invention, a low heat generation property can be improved, and a modulus can be improved.

### DESCRIPTION OF EMBODIMENTS

A tire rubber composition according to the present embodiment (hereinafter, also referred to as a rubber composition) contains (A) a diene rubber containing a tin-modified polybutadiene rubber, (B) carbon black, (C) silica, (D) a specific amino group-containing compound, and (E) a silane coupling agent.

Accordingly, a low heat generation property can be improved, and a modulus can be improved. The reason for this is not intended to be limited, but is presumed as follows. It is considered that dispersibility of the carbon black is improved by reacting and bonding a modified group of the tin-modified polybutadiene rubber to the carbon black by using the tin-modified polybutadiene rubber, a hysteresis loss is reduced, and the low heat generation property is improved. It is considered that by strengthening a bond between the tin-modified polybutadiene rubber and the carbon black, the modulus is improved. In addition, it is considered that by compounding the specific amino group-containing compound, the dispersibility of the carbon black is improved, and the low heat generation property and the modulus are improved. Further, by combining the silica and the silane coupling agent, a rubber-filler interaction caused by a bond between the diene rubber and the silica is strengthened. Therefore, it is considered that, in combination with the above, the rubber-filler interaction is optimized, and thereby the low heat generation property and the modulus are greatly improved.

[(A) Diene Rubber]

The diene rubber as the rubber component contains the tin-modified polybutadiene rubber. The tin-modified polybutadiene rubber is a polybutadiene rubber (BR) modified by a tin compound. The tin-modified polybutadiene rubber is preferably a terminal tin-modified polybutadiene rubber in which a modification group containing tin (Sn) is introduced at a terminal of a polymer molecule.

Examples of the tin compound include: halogenated tin compounds such as tin tetrachloride, methyltin trichloride, dibutyldichlorotin, and tributylchlorotin; allyltin compounds such as tetraallyltin, diethyldiallyltin, and tetra(2-octenyl)tin; tetraphenyltin; and tetrabenzyltin. These compounds may be used alone or in combination of two or more kinds thereof.

In the tin-modified polybutadiene rubber, as a polybutadiene rubber, which is a base for modification, one polymerized using an organolithium catalyst is preferable for enhancing effects of the present embodiment. Examples of the organolithium catalyst include various organolithium compounds generally used in solution polymerization, such as alkyllithium, aryllithium, alkenyllithium, and alkylenedilithium. These organolithium catalysts may be used alone or in combination of two or more kinds thereof.

A polybutadiene rubber having a low-cis content is obtained by polymerization using the organolithium catalyst. A cis content in the tin-modified polybutadiene rubber is preferably 5 mass % to 40 mass %, more preferably 15 mass % to 40 mass %, and may be 25 mass % to 40 mass %. Here, the cis content is a content of a cis-1,4 bond unit in a microstructure of the polybutadiene rubber. A trans content (content of a trans-1,4 bond unit) in the tin-modified polybutadiene rubber is not particularly limited, and may be, for example, 20 mass % to 70 mass %, 30 mass % to 60 mass %, and 40 mass % to 50 mass %. A vinyl content (content of a vinyl-1,2 bond unit) in the tin-modified polybutadiene rubber is not particularly limited, and may be, for example, 1 mass % to 25 mass %, 5 mass % to 20 mass %, or 10 mass % to 20 mass %. The cis content, the trans content, and the vinyl content are calculated based on an integration ratio in a ¹³C-NMR spectrum.

In an embodiment, it is preferable to use, as the tin-modified polybutadiene rubber, a tin-modified polybutadiene rubber having a cis content of 5 mass % to 40 mass %, which is polymerized using an organolithium catalyst. Such a tin-modified polybutadiene rubber is obtained by polymerizing 1,3-butadiene by using an organolithium catalyst and then adding a tin compound, and a molecular terminal is modified by the tin compound.

The diene rubber as the rubber component may contain other diene rubbers together with the tin-modified polybutadiene rubber. Examples of other diene rubbers include a natural rubber (NR), a synthetic isoprene rubber (IR), a butadiene rubber (BR) other than the tin-modified polybutadiene rubber, a styrene-butadiene rubber (SBR), a nitrile rubber (NBR), a chloroprene rubber (CR), a styrene-isoprene copolymer rubber, a butadiene-isoprene copolymer rubber, and a styrene-isoprene-butadiene copolymer rubber, which may be used alone or in combination of two or more kinds thereof.

A diene rubber according to a preferred embodiment contains a tin-modified polybutadiene rubber and a natural rubber. For example, 100 parts by mass of the diene rubber preferably contains 40 parts by mass to 90 parts by mass of the natural rubber and 10 parts by mass to 60 parts by mass of the tin-modified polybutadiene rubber, more preferably 60 parts by mass to 90 parts by mass of the natural rubber and 10 parts by mass to 40 parts by mass of the tin-modified polybutadiene rubber, and still more preferably 70 parts by mass to 85 parts by mass of the natural rubber and 15 parts by mass to 30 parts by mass of the tin-modified polybutadiene rubber.

[(B) Carbon Black]

The carbon black is not particularly limited, and various known products can be used. From a viewpoint of further improving an effect of achieving both the low heat generation property and the modulus, a nitrogen adsorption specific surface area (N₂SA) of the carbon black according to JIS K6217-2:2017 is preferably 100 m²/g to 150 m²/g. The nitrogen adsorption specific surface area of the carbon black is more preferably 120 m²/g to 140 m²/g. Specifically, those of SAF grade (N100 series) and ISAF grade (N200 series) (both ASTM grade) are preferably used, and carbon black of each grade can be used alone or in combination of two or more thereof.

A content of the carbon black is preferably 20 parts by mass to 45 parts by mass, and more preferably 25 parts by mass to 40 parts by mass, with respect to 100 parts by mass of the diene rubber.

[(C) Silica]

The silica is not particularly limited, and examples thereof include wet silica and dry silica. Preferably, wet silica such as silica made by a wet-type precipitation method or silica made by a wet-type gel-method is used.

From the viewpoint of further improving the effect of achieving both the low heat generation property and the modulus, a nitrogen adsorption specific surface area (BET) of the silica according to JIS K6430:2008 Appendix E (multipoint nitrogen adsorption method: BET method) is preferably 150 m²/g to 250 m²/g. The nitrogen adsorption specific surface area of the silica is preferably 160 m²/g to 210 m²/g.

A content of the silica is preferably 5 parts by mass to 30 parts by mass, and more preferably 10 parts by mass to 25 parts by mass with respect to 100 parts by mass of the diene rubber.

[(D) Amino Group-Containing Compound]

The rubber composition according to the present embodiment contains at least one amino group-containing compound selected from the group consisting of a compound (1) and a compound (2).

The compound (1) is represented by the following General Formula (1), and acts as a carbon coupling agent that bonds the diene rubber to the carbon black.

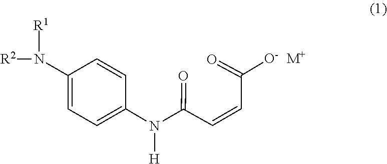

In the Formula (1), R¹ and R² each independently represent a hydrogen atom, an alkyl group having 1 to 20 carbon atoms, an alkenyl group having 2 to 20 carbon atoms, or an alkynyl group having 2 to 20 carbon atoms.

Examples of the alkyl group represented by R¹ and R² include a methyl group, an ethyl group, an n-propyl group, an isopropyl group, an n-butyl group, a sec-butyl group, and a tert-butyl group. Examples of the alkenyl group represented by R¹ and R² include a vinyl group, an allyl group, a 1-propenyl group, and a 1-methylethenyl group.

Examples of the alkynyl group represented by R¹ and R² include an ethynyl group and a propargyl group. The alkyl group preferably has 1 to 10 carbon atoms, and more preferably 1 to 5 carbon atoms. The alkenyl group and the alkynyl group preferably have 2 to 10 carbon atoms, and more preferably 2 to 5 carbon atoms. R¹ and R² are preferably a hydrogen atom or an alkyl group having 1 to 5 carbon atoms, more preferably a hydrogen atom or a methyl group, and still more preferably a hydrogen atom. In an embodiment, —NR¹R² in the Formula (1) is preferably —NH₂, —NHCH₃, or —N(CH₃)₂, and more preferably —NH₂.

M⁺ in the Formula (1) represents a sodium ion, a potassium ion, or a lithium ion, and preferably a sodium ion.

The compound (2) is a dihydrazide compound represented by the following General Formula (2).

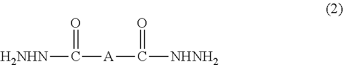

In the Formula (2), A represents a divalent aromatic ring group, a substituted or unsubstituted divalent hydantoin ring group, or a saturated or unsaturated divalent linear hydrocarbon group having 1 to 18 carbon atoms.

Examples of the aromatic ring group in the Formula (2) include a divalent aromatic ring group (which may have a substituent) having 4 to 18 carbon atoms (more preferably 6 to 10 carbon atoms) which may contain a hetero element, such as a phenylene group, a naphthylene group, a pyridylene group, and a quinolylene group. The hydantoin ring group in the Formula (2) may be a divalent group containing a substituted or unsubstituted hydantoin ring. Examples of the linear hydrocarbon group in the Formula (2) include a methylene group, an ethylene group, a propylene group, a tetramethylene group, a hexamethylene group, a heptamethylene group, an octamethylene group, a decamethylene group, an octadecamethylene group, and a 7,11-octadecadienylene group. The linear hydrocarbon group is preferably a divalent saturated linear hydrocarbon group having 2 to 12 carbon atoms (more preferably 4 to 10 carbon atoms).

In an embodiment, A in the Formula (2) is preferably a divalent aromatic ring group having 4 to 18 carbon atoms or a divalent saturated linear hydrocarbon group having 2 to 12 carbon atoms, and more preferably a divalent aromatic ring group having 4 to 18 carbon atoms. More specifically, A is preferably an o-phenylene group, an m-phenylene group, a p-phenylene group, an ethylene group, a tetramethylene group, a heptamethylene group, an octamethylene group, or a decamethylene group. More preferably, A is an o-phenylene group, an m-phenylene group or a p-phenylene group.

Specific examples of the compound (2) include phthalic acid dihydrazide, isophthalic acid dihydrazide, terephthalic acid dihydrazide, 1,3-bis(hydrazinocarboethyl)-5-isopropylhydantoin, succinic acid dihydrazide, adipic acid dihydrazide, azelaic acid dihydrazide, sebacic acid dihydrazide, dodecanediohydrazide, eicosanedioic acid dihydrazide, and 7,11-octadecadiene-1,18-dicarbohydrazide. These compounds may be used alone or in combination of two or more kinds thereof.

A content of the amino group-containing compound is not particularly limited, and is preferably 0.1 parts by mass to 5 parts by mass, more preferably 0.3 parts by mass to 3 parts by mass, and still more preferably 0.5 parts by mass to 2 parts by mass, with respect to 100 parts by mass of the diene rubber. When the content of the amino group-containing compound is 0.1 parts by mass or more, an effect of improving the dispersibility of the carbon black can be enhanced. Here, the content of the amino group-containing compound is a content of the compound (1) when only the compound (1) is used as the amino group-containing compound, is a content of the compound (2) when only the compound (2) is used, and is a total amount of both the compound (1) and the compound (2) when the compound (1) and the compound (2) are used in combination.

[(E) Silane Coupling Agent]

As the silane coupling agent, one containing sulfur in molecules is preferably used, and various sulfur-containing silane coupling agents compounded with silica in the rubber composition can be used.

Specific examples of the silane coupling agent include:

sulfide silanes such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide;

mercaptosilanes such as 3-mercaptopropyltrimethoxysilane, 3-mercaptopropyltriethoxysilane, 3-mercaptopropylmethyldimethoxysilane, 3-mercaptopropyldimethylmethoxysilane, mercaptoethyltriethoxysilane, and “VP Si363” manufactured by Evonik Degussa Corporation, which is represented by a Formula: HS—(CH₂)₃—Si(OC₂H₅)ₘ(O(C₂H₄O)ₖ—C₁₃H₂₇)ₙ (in the Formula, m=average 1, n=average 2, k=average 5); and protected mercaptosilanes (i.e., silane compounds having a thiol ester structure in which a mercapto group is protected by an acyl group) such as 3-octanoylthio-1-propyltriethoxysilane (Formula: CH₃(CH₂)₆C(═O)S—(CH₂)₃—Si(OC₂H₅)₃), and 3-propionylthiopropyltrimethoxysilane.

These silane coupling agents may be used alone or in combination of two or more kinds thereof.

A content of the silane coupling agent is not particularly limited, and is preferably 0.1 parts by mass to 5 parts by mass, more preferably 0.3 parts by mass to 3 parts by mass, and still more preferably 0.5 parts by mass to 2 parts by mass, with respect to 100 parts by mass of the diene rubber.

[Other Components]

In addition to the components described above, various additives generally used in the rubber composition, such as zinc oxide, stearic acid, an antioxidant, an oil, a wax, a vulcanization agent, and a vulcanization accelerator, can be compounded in the rubber composition according to the present embodiment.

Sulfur is preferably used as the vulcanization agent.

A content of the vulcanization agent is not particularly limited, and is preferably 0.1 parts by mass to 10 parts by mass, more preferably 0.5 parts by mass to 5 parts by mass, and may be 1 part by mass to 3 parts by mass with respect to 100 parts by mass of the diene rubber.

Examples of the vulcanization accelerator include various vulcanization accelerators such as sulfenamide-based, thiuram-based, thiazole-based, and guanidine-based vulcanization accelerators, which may be used alone or in combination of two or more kinds thereof. A content of the vulcanization accelerator is not particularly limited, and is preferably 0.1 parts by mass to 7 parts by mass, more preferably 0.5 parts by mass to 5 parts by mass, and may be 1 part by mass to 3 parts by mass with respect to 100 parts by mass of the diene rubber.

The rubber composition according to the present embodiment can be produced by kneading according to a common method by using a mixer such as a Banbury mixer, a kneader, or a roll that is generally used. That is, for example, in a first mixing stage (non-productive kneading step), the carbon black, the silica, the amino group-containing compound, the silane coupling agent, and an additive other than a vulcanization agent and a vulcanization accelerator are added to and mixed with the diene rubber. Next, a vulcanization agent and a vulcanization accelerator are added to and mixed with the obtained mixture in a final mixing stage (productive kneading step). Accordingly, an unvulcanized rubber composition can be prepared.

The rubber composition according to the present embodiment can be used as a tire rubber composition. Examples of the tire include pneumatic tires having various applications and sizes such as a tire for a passenger vehicle and a heavy duty tire for a truck or a bus. Preferably, the rubber composition is used as a rubber composition for a heavy duty tire.

A tire according to an embodiment is produced using the above rubber composition. That is, the tire includes a rubber portion formed of the above rubber composition. Examples of application portions of the tire include a tread rubber and a sidewall rubber, and preferably a tread rubber.

The tread rubber of the tire has a two-layer structure including a cap rubber and a base rubber, or has a single-layer structure in which the cap rubber and the base rubber are integrated with each other. In the single-layer structure, the tread rubber may be formed of the above rubber composition. In the two-layer structure, the cap rubber in an outer side to be in contact with a road surface may be formed of the above rubber composition, and the base rubber disposed on an inner side of the cap rubber may be formed of the above rubber composition.

A method for manufacturing the tire is not particularly limited. For example, the above rubber composition is molded into a predetermined shape by extrusion according to a common method, and the obtained molded product is combined with other parts to produce an unvulcanized tire (green tire). For example, the tread rubber is produced using the above rubber composition, and the unvulcanized tire is produced by combining with other tire members. Thereafter, the tire can be manufactured by vulcanization molding at 140° C. to 180° C., for example.

### EXAMPLES

Hereinafter, Examples will be illustrated, but the invention is not limited to these Examples.

### Examples 1 to 8 and Comparative Examples 1 to 4

First, in a first mixing stage, compounding ingredients excluding sulfur and a vulcanization accelerator were added to a diene rubber and kneaded (discharge temperature=160° C.) by using a Banbury mixer in accordance with compounding (part by mass) shown in Table 1 below, and then in a final mixing stage, sulfur and a vulcanization accelerator were added to the obtained kneaded material and kneaded (discharge temperature=90° C.) to prepare a rubber composition. Details of each component in Table 1 are as follows.
Natural rubber: RSS #3
Unmodified BR: polybutadiene rubber polymerized using an Nd catalyst, “Buna CB22” (microstructure: cis content: 98.2 mass %, trans content: 1.4 mass %, vinyl content: 0.5 mass %) manufactured by LANXESS
Tin-modified BR: tin-modified polybutadiene rubber polymerized using a Li catalyst, “BR500” (microstructure: cis content: 35.0 mass %, trans content: 49.2 mass %, vinyl content: 15.7 mass %) manufactured by JSR Corporation
Carbon black: “SEAST 9” (N2SA: 139 m²/g) manufactured by Tokai Carbon Co., Ltd.
Compound (1): sodium (2Z)-4-[(4-aminophenyl)amino]-4-oxo-2-butenoate, —NR¹R² is —NH₂ and M⁺ is Na⁺ in Formula (1), “SUMILINK 200” manufactured by Sumitomo Chemical Co., Ltd.
Compound (2)-1: isophthalic acid dihydrazide, A in Formula (2) is an m-phenylene group, “IDH” manufactured by Otsuka Chemical Co., Ltd.
Compound (2)-2: adipic acid dihydrazide, A in formula (2) is a tetramethylene group, “ADH” manufactured by Otsuka Chemical Co., Ltd.
Silica: “Ultrasil VN3” (BET: 180 m²/g) manufactured by Evonik Corporation
Silane coupling agent 1: bis(3-triethoxysilylpropyl) disulfide, “Si75” manufactured by Evonik Corporation
Silane coupling agent 2: 3-octanoylthio-1-propyltriethoxysilane, “NXT” manufactured by Momentive
Zinc oxide: “Zinc oxide No. 2” manufactured by Mitsui Mining & Smelting Co., Ltd.
Stearic acid: “Beads Stearic Acid” manufactured by NOF CORPORATION
Antioxidant: “NOCRAC 6C” manufactured by Ouchi Shinko Chemical Industry Co., Ltd.
Vulcanization accelerator: “SOXINOL CZ” manufactured by Sumitomo Chemical Co., Ltd.
Sulfur: “Powdered Sulfur” manufactured by Tsurumi Chemical Industry Co., Ltd.

The obtained rubber compositions were subjected to measurement and evaluation regarding a low heat generation property and a modulus by using a test piece having a predetermined shape vulcanized at 160° C. for 30 minutes. Each evaluation method is as follows.
Low heat generation property: a loss coefficient tan δ was measured at a frequency of 10 Hz, a static strain of 10%, a dynamic strain of 1%, and a temperature of 60° C. by using a viscoelasticity tester manufactured by UBM Co., Ltd., and a reciprocal of the measured value was represented by an index with a value in Comparative Example 1 set to 100. The higher the numerical value, the lower the tan δ and the better the low heat generation property.
Modulus: according to JIS K6251:2017, tensile strength was measured by performing a tensile test (dumbbell No. 3 shape), and the modulus was represented by an index with a value in Comparative Example 1 set to 100. The higher the numerical value, the higher the modulus and the better the reinforcing property.

TABLE 1

| | Comp. | Comp. | Comp. | Comp. | | | | | | | | |
|---|---|---|---|---|---|---|---|---|---|---|---|---|
| | Exp. 1 | Exp. 2 | Exp. 3 | Exp. 4 | Exp. 1 | Exp. 2 | Exp. 3 | Exp. 4 | Exp. 5 | Exp. 6 | Exp. 7 | Exp. 8 |
| Compounding | | | | | | | | | | | | |
| (part by mass) | | | | | | | | | | | | |
| Natural rubber | 80 | 80 | 80 | 80 | 80 | 80 | 80 | 80 | 80 | 80 | 80 | 80 |
| Unmodified BR | 20 | 20 | — | — | — | — | — | — | — | — | — | — |
| Tin-modified BR | — | — | 20 | 20 | 20 | 20 | 20 | 20 | 20 | 20 | 20 | 20 |
| Carbon black | 40 | 40 | 40 | 10 | 45 | 40 | 30 | 25 | 20 | 40 | 40 | 40 |
| Compound (1) | — | 1 | — | 1 | 1 | 1 | 1 | 1 | 1 | — | — | 1 |
| Compound (2)-1 | — | — | — | — | — | — | — | — | — | 1 | — | — |
| Compound (2)-2 | — | — | — | — | — | — | — | — | — | — | 1 | — |
| Silica | 10 | 10 | 10 | 40 | 5 | 10 | 20 | 25 | 30 | 10 | 10 | 10 |
| Silane coupling | 1 | 1 | 1 | 1 | 1 | 1 | 1 | 1 | 1 | 1 | 1 | — |
| agent 1 | | | | | | | | | | | | |
| Silane coupling | — | — | — | — | — | — | — | — | — | — | — | 1 |
| agent 2 | | | | | | | | | | | | |
| Zinc oxide | 3 | 3 | 3 | 2 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 |
| Antioxidant | 1 | 1 | 1 | 1 | 1 | 1 | 1 | 1 | 1 | 1 | 1 | 1 |
| Vulcanization | 1.4 | 1.4 | 1.4 | 1.4 | 1.4 | 1.4 | 1.4 | 1.4 | 1.4 | 1.4 | 1.4 | 1.4 |
| accelerator | | | | | | | | | | | | |
| Sulfur | 1.6 | 1.6 | 1.6 | 1.6 | 1.6 | 1.6 | 1.6 | 1.6 | 1.6 | 1.6 | 1.6 | 1.6 |
| Evaluation (index) | | | | | | | | | | | | |
| Low heat generation | 100 | 107 | 110 | 103 | 126 | 125 | 131 | 137 | 120 | 124 | 119 | 120 |
| property | | | | | | | | | | | | |
| Modulus | 100 | 105 | 105 | 90 | 110 | 110 | 115 | 115 | 110 | 112 | 112 | 110 |

Results are shown in Table 1. From a comparison of Examples 2, 6, and 7 with Comparative Examples 2 and 3, compared to substitution with only a tin-modified polybutadiene rubber or substitution with only an amino group-containing compound in Comparative Example 1, the low heat generation property is significantly improved and the modulus is also improved by using both the tin-modified polybutadiene rubber and the amino group-containing compound in combination, and a synergistic effect is obtained.

In addition, according to Examples 1 to 5, the low heat generation property and the modulus are improved by reducing the content of the carbon black and increasing the content of the silica. However, when the contents of the carbon black and the silica reach a peak at about the same content, the carbon black is 10 parts by mass or less, and the silica is 40 parts by mass or more, as in Comparative Example 4, the modulus deteriorates compared to Comparative Example 1 and an effect of improving the low heat generation property is impaired.

In various numerical ranges described in the specification, upper limit values and lower limit values thereof can be freely combined, and all combinations thereof are described in the present specification as preferable numerical ranges. In addition, the description of the numerical range of “X to Y” means X or more and Y or less.

Although certain embodiments of the invention have been described above, these embodiments have been presented by way of example only, and are not intended to limit the scope of the invention. These embodiments can be implemented in various other forms, and various omissions, substitutions, and changes can be made without departing from the spirit of the invention. These embodiments, their omissions, substitutions, changes, and the like are included in the invention described in the scope of claims and equivalents thereof, as well as being included in the scope and gist of the invention.

What is claimed is:

1. A tire rubber composition comprising:
a diene rubber containing a tin-modified polybutadiene rubber;
20 parts by mass to 45 parts by mass of carbon black and 5 parts by mass to 30 parts by mass of silica with respect to 100 parts by mass of the diene rubber;
at least one selected from the group consisting of a compound represented by the following General Formula (1) and a compound represented by the following General Formula (2); and
a silane coupling agent,
wherein 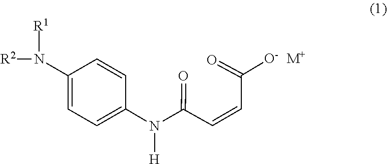
in the Formula (1), R¹ and R² each independently represent a hydrogen atom, an alkyl group having 1 to 20 carbon atoms, an alkenyl group having 2 to 20 carbon atoms, or an alkynyl group having 2 to 20 carbon atoms, and M⁺ represents a sodium ion, a potassium ion, or a lithium ion, and 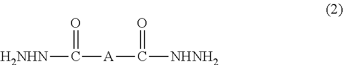
in the Formula (2), A represents a divalent aromatic ring group, a substituted or unsubstituted divalent hydantoin ring group, or a saturated or unsaturated divalent linear hydrocarbon group having 1 to 18 carbon atoms.

2. The tire rubber composition according to claim 1, wherein the tin-modified polybutadiene rubber is a tin-modified polybutadiene rubber polymerized using an organolithium catalyst.

3. The tire rubber composition according to claim 1, wherein a cis content in the tin-modified polybutadiene rubber is 5 mass % to 40 mass %.

4. The tire rubber composition according to claim 2, wherein a cis content in the tin-modified polybutadiene rubber is 5 mass % to 40 mass %

5. The tire rubber composition according to claim 1, wherein a nitrogen adsorption specific surface area of the carbon black according to JIS K6217-2:2017 is 100 m²/g to 150 m²/g, and a nitrogen adsorption specific surface area of the silica according to JIS K6430:2008 Appendix E is 150 m²/g to 250 m²/g.

6. The tire rubber composition according to claim 1, wherein 100 parts by mass of the diene rubber contains 40 parts by mass to 90 parts by mass of a natural rubber and 10 parts by mass to 60 parts by mass of the tin-modified polybutadiene rubber.

7. The tire rubber composition according to claim 1, wherein —NR¹R² in the Formula (1) is —NH₂, —NHCH₃, or —N(CH₃)₂, and the compound represented by the Formula (2) is at least one selected from the group consisting of phthalic acid dihydrazide, isophthalic acid dihydrazide, terephthalic acid dihydrazide, 1,3-bis(hydrazinocarboethyl)-5-isopropylhydantoin, succinic acid dihydrazide, adipic acid dihydrazide, azelaic acid dihydrazide, sebacic acid dihydrazide, dodecanediohydrazide, eicosanedioic acid dihydrazide, and 7,11-octadecadiene-1,18-dicarbohydrazide.

8. A tire, which is produced using the tire rubber composition according to claim 1.

9. A tire, which is produced using the tire rubber composition according to claim 2.

10. A tire, which is produced using the tire rubber composition according to claim 3.

11. A tire, which is produced using the tire rubber composition according to claim 4.

12. A tire, which is produced using the tire rubber composition according to claim 5.

13. A tire, which is produced using the tire rubber composition according to claim 6.

14. A tire, which is produced using the tire rubber composition according to claim 7.

15. The tire according to claim 8, which is a heavy duty tire.
